(19) United States
(12) Patent Application Publication
(10) Pub. No.: US 2025/0125471 A1
(43) Pub. Date: Apr. 17, 2025

(54) STACKABLE BATTERY MODULE AND BATTERY SYSTEM FOR A BATTERY ELECTRIC VEHICLE

(71) Applicant: Lisa Dräxlmaier GmbH, Vilsbiburg (DE)

(72) Inventors: Michael STECKEL, Vilsbiburg (DE); Johann SCHWIMMBECK, Falkenberg (DE); Christian BLASCHKE, Landshut (DE); Guido HOFER, Weng (DE); Manuel HOFER, Weng (DE); Alexander HAHN, Roettenbach (DE); Stefan SEIDL, Landshut (DE)

(73) Assignee: Lisa Dräxlmaier GmbH, Vilsbiburg (DE)

(21) Appl. No.: 18/917,477

(22) Filed: Oct. 16, 2024

(30) Foreign Application Priority Data
Oct. 16, 2023 (DE) 10 2023 128 242.5

(51) Int. Cl. H01M 50/262; H01M 10/6557; H01M 50/249

(52) U.S. Cl. CPC H01M 50/262; H01M 10/6557; H01M 50/249

(57) ABSTRACT

A stackable battery module for a battery system of a battery electric vehicle includes a plurality of battery cells and a battery module housing arranged to frame the plurality of battery cells. A plurality of battery modules interlock to form a battery module stack and laterally encase the battery module stack when several battery modules are stacked. The battery module includes centering elements arranged on the outside surfaces of the battery module housing to secure and center the stacked battery module inside a housing of the battery system. The battery module housing has a laterally framing tongue element and a laterally framing groove element corresponding to the tongue element. The tongue element of one battery module interlocks with the groove element of further battery module when the battery modules are stacked with an additional battery module to form a battery module stack and a coolant channel between the battery modules.

### CROSS-REFERENCE TO RELATED APPLICATIONS

This application which claims priority to and the benefit of DE 10 2023 128 242.5 filed on Oct. 16, 2023. The disclosure of the above application is incorporated herein by reference.

### FIELD

The present disclosure relates to the field of electric battery systems and battery electric vehicles, particularly electric-powered vehicles.

### BACKGROUND

The statements in this section merely provide background information related to the present disclosure and may not constitute prior art.

Battery modules or battery stacks of battery systems for battery electric vehicles are traditionally screwed into a housing or secured within an additional holder, which in turn is screwed or otherwise attached to the housing. In either case, fasteners (screws) and tools or other assembly components may be used for assembly, which add expense and weight. The screwing of components brings with it higher time and material expenditure during manual as well as also automated assembly. As a rule, the screw connection must be monitored with regard to torque and angle of rotation since a deviation from the original design of the screw connection may lead to damage of the components or insufficient attachment.

It is furthermore desired to achieve the shortest possible battery recharge. In this case, the cells may be actively cooled due to the developing power dissipation and the heat caused thereby (power dissipation is the square of the current).

### SUMMARY

This section provides a general summary of the disclosure and is not a comprehensive disclosure of its full scope or all of its features.

The present disclosure relates to a stackable battery module and battery system for battery electric vehicles, as well as a method for producing said battery system.

The present disclosure provides an easier and more secure assembly for a battery electric vehicle in which the disadvantages mentioned above do not occur.

The present disclosure provides a method for assembling a battery system for a battery electric vehicle that makes due without fasteners, such as screws, etc. and tools to secure the battery modules.

The present disclosure provides a method for assembling a battery system for battery electric vehicles that makes possible a cooling of the battery cells without the additional seals to seal in the coolant.

The present disclosure provides utilizing and mounting a stack of modules, that is, a connected group of battery modules, in the battery housing within the scope of the assembly of a battery system for a partially or fully electric vehicle. The stack of modules has centering elements on its outer surfaces, which are positively accommodated in or between the housing parts and can sufficiently fix the stack in any direction after the housing is closed.

The battery modules described in this disclosure can be mounted into nearly any battery system for electric vehicles and their mounting in the housing presents a set of problems in each of these systems, though this present disclosure provides a solution for each. Issues such as production costs, installation time and complexity, as well as savings in weight, and the number of components are the main focus. The mounting method described here refers primarily to battery systems whose modules have a plastic housing but can also be applicable to other materials or modular frame types.

The mounting method described above by means of centering elements located on the modules brings with it a savings in time for the installation of the battery system. No additional screwdriving tools and mounting means as well as components are needed, which has a positive effect on the production costs and the total weight of the battery system. The reduction in screw connections and work steps also helps reduce potential for flaws in production. In the case where the battery system needs to be repaired or discarded, its dismantling and the recycling connected therewith is simplified by means of the described method. The reduction of small metal parts, such as screws, helps to reduce the risk of a potential short circuit during assembly.

Another concept behind the present disclosure is based on a battery system for a battery electric vehicle and a corresponding production process, which achieves a cooling of the battery cells without using additional seals for sealing in the coolant. The battery system is based on the tongue and groove concept, which represents a special type of seal in which a 2K injection molding method as well as also an actual seal can be omitted, which significantly lowers the costs. If the modules expand as a consequence of an elevation of the temperature, the tongue is inserted deeper into the groove. The sealing function is not affected thereby.

To obtain the openings in the injected plastic module, so-called “sliders” (movable parts in the tool) may be used. If the opening is located at the edge of the component, a notch (recess) of the edge (shown by means of an elevation in the tool) will suffice. The present disclosure presented herein can omit such a slider, which simplifies the tool and lowers the costs.

If the modules expand due to an elevation of the temperature, the tongue element travels deeper into the groove. In order to inhibit this movement from causing a change of the throttling effect in this this connector channel, the narrowest point in the channel is not at the bottom of the notch, but instead runs parallel to the direction of movement of the tongue element. Thus, the cross section at the narrowest point of the channel is not influenced by the relative movement between the tongue element and groove element, whereby it is provided that the flow volume remains constant.

The production costs can be reduced by omitting the sliders in the tool.

In this disclosure are described battery electric vehicles, or EVs. In such battery electric vehicles (BEV, PHEV, etc.), the energy for driving the vehicles is drawn from an accumulator (otherwise known as a battery). The battery generally includes of cells connected in parallel or in series. For this purpose, the cells are commonly fixed in module housings, and these are in turn fixed in battery housings. In this disclosure are presented measures which compensate for (the various) changes in size due to temperature fluctuations.

It is furthermore desired to achieve the shortest possible battery recharge. For this purpose, the cells are actively cooled as a result of the heat generated by the power dissipation (power dissipation increases with the square of the current), as described in this disclosure. So-called direct or immersion cooling is particularly effective. The coolant medium in this method may not or must be non-conductive. A system is described, which configures a cooling channel by joining two module housings and a coolant distributor. In this disclosure, a battery system is described in which the coolant channel and the coolant distributor are configured so compact that the cooling medium can flow from one side to the other, for example, from front to back (coolant distributor) and from bottom to top (coolant channel), but any other combinations are also possible. In this disclosure is disclosed a solution in which additional seals can be omitted for sealing the cooling channel and the coolant distributor. The solution is based on the tongue and groove concept, in which the tongue and groove connection is configured to be so flexible that component tolerances changes in size due to temperature fluctuations can be compensated.

To provide that the coolant can reach the cooling channel from the coolant distributor (also called “manifold”), the coolant distributor has openings in the area of the cooling channel. Ideally, approximately the same amount of cooling fluid should flow from the coolant distributor into each coolant channel (which is formed by joining two modules; several modules are joined forming a string (or block or bank)). A solution is presented for this purpose in which the coolant distributor is relatively large in relation to the openings in the cooling channels. In this case, all the modules can be identically produced (off-tool). Even when the modules are connected in a string there is no need to pay attention to the order of the modules.

This disclosure describes battery modules and battery module stacks.

The battery modules comprise a plurality of battery cells. A battery cell or cell is an electric or galvanic cell, and as such, is an electrochemical energy storage device and energy converter. When discharged, the stored chemical energy is converted into electrical energy. This energy can be utilized by an electric electrical consumer.

The individual battery modules can be stacked one on top of the other to form a battery module stack.

HV batteries include of a plurality of cells. These cells are joined into groups, which are referred to as battery cell groupings or cell groupings. These cell groupings are monitored and balanced, that is, held in balance by the CSC (cell supervising circuit), keeping them in equilibrium. The total number of groups determines the battery's voltage. For example, 110 cell groups×3.65=401.5V are obtained, which corresponds to a 400 V battery. This voltage is multiplied by the number of cells in a group multiplied by the capacity of a single cell (for example, 5 Ah) yields the total capacity of the battery.

A plurality of cell groupings can be located in a battery module. A module is usually referred to as a housing for various cells. However, these cells may not form part of a grouping. This means that several groupings of cells can be arranged in a module. A cell grouping is comprised by individual battery cells, which are connected in a parallel circuit, so that they share a common voltage potential.

According to a first aspect, the present disclosure provides a stackable battery module for a battery system of a battery electric vehicle, comprising: a plurality of battery cells; a housing of the battery module, which is arranged so as to frame the plurality of battery cells; wherein when several battery modules are stacked to form a battery module stack, the housings of the battery modules for the respective battery modules interlock and laterally encase the battery module stacks; and one or several centering elements, which are arranged on one or several of the outer surfaces of the battery module housings, wherein the centering elements are configured for mounting and centering the stacked battery modules in the housing of the battery system.

With the aid of such a stackable battery module can be assembled a battery system which can be make do without fasteners such as, for example, screws, etc. or tools to secure the battery modules. The fastening and simultaneous centering is achieved solely by means of the interlocking of the centering elements with the corresponding elements on the housing.

According to an example of the stackable battery modules, one or several centering elements are formed as one piece with the housing of the battery module.

This offers the advantage of simplifying production, for example, in an injection molding method. The injection molded parts obtained therewith are stable and robust.

According to an example of the stackable battery modules, one or several centering elements are configured so as to interlock with corresponding counter-centering elements of the housing.

A strong attachment can be achieved thereby with a simultaneous centering of the stackable battery modules in the housing of the battery system.

According to an example of the stackable battery modules, the counter-centering elements of the housing are designed as centering recesses and/or centering grooves.

In doing so, the centering elements can interlock at the suitable location in the centering recesses or centering grooves. The centering recesses allow, for example, a centering in two dimensions, while the centering grooves allow a centering in one dimension. Various centering concepts can consequently be realized. The centering elements can be configured to be either monodirectional or bidirectional.

According to an example of the stackable battery module, one or several centering elements are configured so as to secure the stacked battery module in the battery system housing in three different spatial dimensions.

If several centering elements are installed, a centering of the battery module stacks can be carried out in three directions in space within the housing.

According to an example of the stackable battery modules, one or several centering elements are configured in cross or beam shape.

A centering along one direction in space, namely in direction of the beam, can be realized with a beam-shaped shape. A centering along two directions in space, namely along the two beams of the cross, can be realized with a cross shape. However, with a cross shape of the centering element, the second beam can only be used to stabilize the centering element without configuring a centering in the second spatial direction.

According to an example of the stackable battery modules, a respective centering element is configured for centering the stacked battery module in transversal and/or longitudinal direction of the corresponding outer surface of the battery module housing.

A centering can be carried out by means of a respective centering element in two spatial directions, namely a transversal and longitudinal direction in reference to the respective outer surface of the battery module housing on which the centering element is installed. The transversal direction refers to the direction along the module wall, that is, in direction of assembly the modules. As described above, the centering element can, however, also be configured in such a way that a centering can only be realized in one spatial direction.

According to a second aspect, the present disclosure provides a battery system for a battery electric vehicle, comprising: a plurality of stackable battery modules according to a first aspect, which are stacked to form a stack of battery modules, wherein the battery module housings of the respective battery modules interlock and laterally encase the battery module stacks; a housing, which encases the battery module stack; wherein the housing comprises a plurality of counter-centering elements configured for interlocking with one or several centering elements of the battery module housings so that the battery module stack is secured and centered in the housing.

Such a battery system can be assembled without the need of fasteners, such as screws, etc. or tools to install the battery modules. The installation and simultaneous centering are carried out only by interlocking the centering elements in the corresponding counter-centering elements on the housing.

According to an example of the battery system, the housing comprises two or several housing sections, which can be assembled to make the housing, wherein one or several centering elements interlock with the corresponding counter-centering elements of the housing and secure and center the battery module stack in the housing when the housing sections are assembled to form the housing.

This offers the advantage of facilitating both the assembly and disassembly of the battery system. The centering elements are easily inserted into the corresponding counter-centering elements on the housing and offer a simple installation possibility with a robust and stable configuration.

According to a third aspect, the present disclosure provides a method for producing a battery system for a battery electric vehicle, comprising: making available a plurality of battery modules with respectively a plurality of battery cells; a battery module housing arranged framing a plurality of battery cells; and one or several centering elements arranged on one or several outer surfaces of the battery module housing; stacking the battery modules so as to form a battery module stack, wherein the battery module housings of the respective battery modules interlock during stacking and laterally encase the stacked battery modules; inserting the battery module stack into a battery system housing, whereby the centering elements of the respective battery module housing secure and center the battery module stack in the housing during insertion.

With such a method a battery system can be easily produced without the need for fasteners, such as, for example, screws, etc. and tools for mounting a battery module. The fastening and simultaneous centering is achieved solely by means of the interlocking of the centering elements with the respective elements on the housing.

According to a fourth aspect, the present disclosure provides a stackable battery module for the battery system of a battery electric vehicle, comprising: a plurality of battery cells; and battery module housing, which is arranged framing the plurality of battery cells; whereby the battery module housing has a laterally framing tongue element as well as a laterally framing groove element, which fits with the tongue element, wherein during stacking of the battery module with an additional battery module to form a battery module stack, the tongue element of the battery module engages into the groove element of a further battery module and forms a coolant channel between the battery module and the further battery module.

With such a stackable battery module can be installed a battery system which makes possible an efficient cooling of the battery cells without the need for additional seals for sealing in the coolant. The sealing effect is created by the interlocking of the tongue element of a respective battery module in the groove element of an adjacent battery module of the module stack.

According to an example of the stackable battery modules, the tongue element and/or groove element can be provided as one piece with the battery module housing.

This offers the advantage of simplifying production, for example, in an injection molding method. The injection molded parts obtained therewith are stable and robust.

According to an example of the stackable battery modules, the tongue from the battery module together with the groove element of a further battery module forms the coolant channel between the battery module and the further battery module closely opposite to an outlet of coolant.

In this way is achieved the advantage that a suitable sealing of the coolant channel is created to inhibit coolant loss from the coolant channel by means of a simple insertion of the tongue element into the groove element.

According to an example of the stackable battery modules, the insertion of the tongue element of one battery module into the groove element of the further battery module forms a tongue and groove type connection.

The tongue and groove type connection is a plug connection that is easily produced by means of the insertion of the tongue element from one battery module into the groove element of the adjacent battery module in the battery module stack. It inhibits a shifting of the two adjacent battery modules relative to one another. The groove element can be shaped as an elongated, for the most part rectangular recess (the groove) in the battery module housing. The tongue or the tongue element fits positively into the groove (in a kind of positive form of the groove).

According to an example of the stackable battery modules, the tongue and groove connection is configured so as to positively fit perpendicularly to the interlocking direction of the tongue element with the groove element.

A stable connection is thus created perpendicularly to the interlocking direction of the tongue element with the groove element.

According to an example of the stackable battery modules, the tongue and groove connection is configured to slide together in the interlocking direction.

In this way can be taken into account temperature fluctuations as a consequence of which the tongue element can expand and contract in the groove element. The connection is consequently robust and resistant to breakage.

According to an example of the stackable battery module, the groove element has a notch, which configures the connection of the coolant distributor to the coolant channel between the battery module and the further battery module once the tongue element has interlocked with groove element.

The coolant channel can be configured in this notch, while a tight connection between the two battery modules can be obtained at the remaining locations which is particularly close opposite to a coolant outlet.

According to a fifth aspect, the present disclosure provides a stackable battery module for a battery system of a battery electric vehicle, comprising: a plurality of stackable battery modules according to the fourth aspect, which is stacked to form a battery module stack, wherein respectively the tongue element of one battery module interlocks with the groove element of a corresponding battery module and forms a coolant channel between the battery module and the further battery module; and a housing that encases the battery module stack and seals it against loss of coolant.

Such a battery system enables an efficient cooling of the battery cells, without the need for additional seals to seal in the coolant. The sealing effect is created by means of the interlocking of the tongue element of a respective battery module in the groove element of an adjacent battery module in the module stack.

According to an example of the battery system, the battery system comprises: a coolant distributor for introducing coolant into the coolant channels of the stackable battery modules; wherein a cross section of the coolant distributor, via which the coolant can be introduced into the coolant channels between the battery modules, is many times larger than the cross section of the respective coolant channels between the battery modules.

A consistent flow of coolant is provided with such dimensions, so that coolant equally cools all of the battery cells, and no temperature differences occur depending on the installation location of the battery cells.

According to a sixth aspect, the present disclosure provides a method for producing a battery system for a battery electric vehicle, comprising: making available a plurality of battery modules each module having a plurality of battery cells; and arranging a battery module housing framing the plurality of battery cells, wherein the battery module housing has a laterally framing tongue element and a laterally framing groove element, which first with a tongue element; and stacking the battery module with a further battery module to form a battery module stack, wherein the tongue element of the battery module interlocks with the groove element of the further battery module during stacking and a coolant channel is formed between the battery module and the further battery module.

A battery system can be produced with such a method, which makes possible an efficient cooling of the battery cells without the need for additional seals for sealing in the coolant. The sealing effect is achieved by means of the interlocking of the tongue element of a respective battery module in the groove element of an adjacent battery module of the module stack.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a stackable battery module according to the present disclosure having centering elements in transversal direction and/or longitudinal direction according to an example;

FIG. 2 is a perspective view of a housing according to the present disclosure of a battery system having counter-centering elements according to an example, in which the upper housing section is depicted;

FIG. 3 is a perspective view of a battery system according to the present disclosure having stacked battery module and lower housing section according to an example;

FIG. 4 is a sectional view of the battery module stack in the lower housing section;

FIG. 5 is a sectional view of a battery module in the closed housing;

FIG. 6 is a perspective view of the battery system to illustrate the centering concept of the module stack in the housing;

FIG. 7 is a schematic representation of a method according to the present disclosure for producing a battery system for a battery electric vehicle;

FIG. 8 is a perspective view of a battery system according to the present disclosure having two exemplary stackable battery modules according to an example;

FIG. 9 is a detail perspective view of the coolant distributor and breakthrough to the coolant channel between the two battery modules of FIG. 8 according to an example;

FIG. 10A is a perspective view of the battery module of FIG. 8 displaying the laterally framed groove element according to an example;

FIG. 10B is a perspective view of the battery module of FIG. 8 displaying the laterally framed tongue element according to an example;

FIG. 10C is a perspective view of the battery module of FIG. 8 illustrating the configuration of the coolant manifold and breakthrough to the coolant channel between the groove element and the tongue element according to an example;

FIG. 11A is a perspective view of the battery module of FIG. 8 displaying the tongue and groove connection according to an example;

FIG. 11B is an enlarged representation of a tongue and groove connection of FIG. 11A;

FIG. 12A-C are a perspective views of the tongue and groove connection and configuration of the coolant distributor and breakthrough to the coolant channel between the groove element and tongue element of two stacked battery modules according to an example; and

FIG. 13 shows a schematic representation of a method 1300 according to the present disclosure for producing a battery system for a battery electric vehicle.

The figures are merely schematic representations and serve only to explain the present disclosure. Elements that are identical or have the same effect are provided with the same reference numerals throughout.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

The aspects and examples are described with reference to the drawings, wherein identical reference numerals generally refer to identical elements. In the following description are presented numerous specific details for explanatory purposes with the goal of providing an in-depth understanding of one or several aspects of the present disclosure. To a person skilled in the art, one or several aspects or examples can be implemented with a lesser degree of specific detail. In other cases, known structures and elements are represented in schematic form in order to facilitate the description of one or several aspects or examples. It is understood that other examples can be utilized, and structural or logical modifications can be made without deviating from concept of the present disclosure.

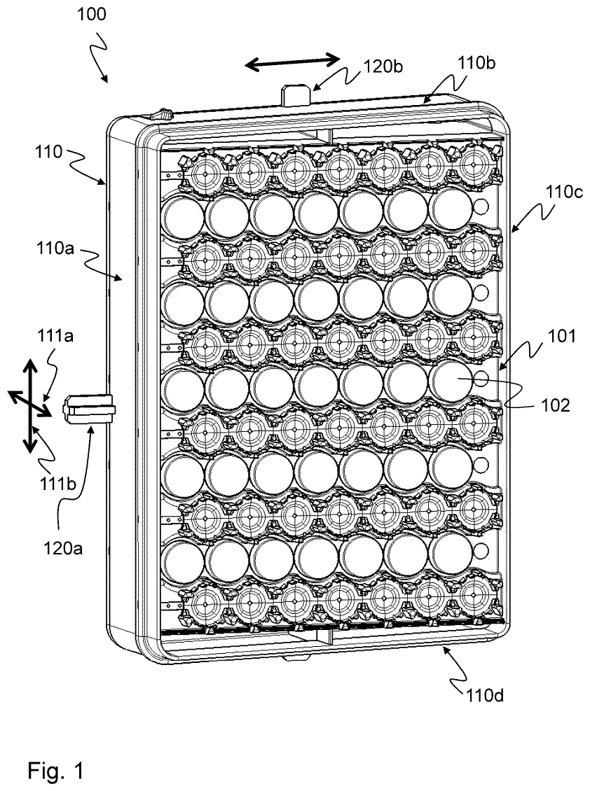

FIG. 1 shows a 3D representation of a stackable battery module 100 according to the present disclosure having centering elements in transversal direction 111a and/or longitudinal direction 111b according to one example. The transversal direction 111a refers herein to a module assembly direction along the module wall. The longitudinal direction 111b points in vertical direction in FIG. 1.

The battery module 100 comprises a plurality of battery cells 102, which are combined to form a plurality of battery cell groupings. A battery cell is an electric or galvanic cell and is thus an electrochemical energy storage device and energy converter. When discharged, stored chemical energy is converted into electrical energy. This energy can then be used by an electrical consumer. The battery cells 102 can take, for example, the shape of round cells 102 or cylindrical cells, as shown as an example in FIG. 1. They can alternatively also be shaped as prismatic cells or pouch cells or also according to another cell type.

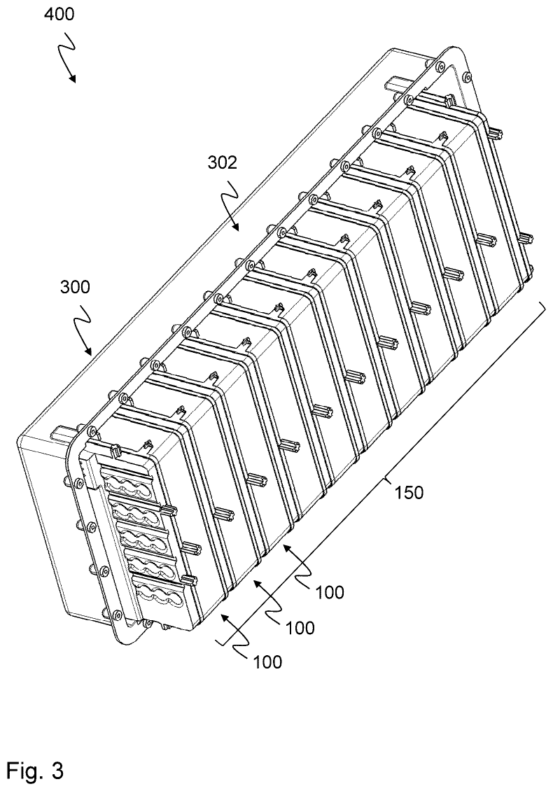

In the example of FIG. 1, the battery module 100 comprises 7 battery cells 102 arrayed in 11 rows per grouping. The individual battery modules 100 can be stacked one on top of another in order to form a battery stack or battery module stack 150, as shown as an example in FIG. 3. If, for example, 10 such battery modules 100 stacked one on top of another, then the battery module stack is comprised by 10×11=110 cell groupings, which corresponds to a 400V battery. The battery cells 102 can be combined and encased in a battery module housing 110, which also serves as carrier for the battery cells 102.

The stackable battery module 100 of FIG. 1 is intended for a battery system 400 of a battery electric vehicle. The stackable battery module 100 comprises a plurality of battery cells 102; a battery module housing 110, which is arranged framing or all-around the battery cells 102. The battery module housing 110 can be configured, for example, as a frame that laterally frames the battery cells 102. When a plurality of battery modules 100 are stacked to form a battery stack 150, the battery module housings 110 of the respective battery modules 100 interlock with each other and laterally encases the battery module stack 150.

The stackable battery module 100 comprises one or several centering elements 120a, 120b, which are positioned on one or several of the outer surfaces 110a, 110b, 110c, 110d of the battery module housing 110. The centering elements 120a, 120b are configured so as to secure and center the stacked battery module 100 in a housing 300 of the battery system 400.

The centering elements 120a, 120b can be shaped as one piece with the battery module housing 110, for example, as a single injection molded part.

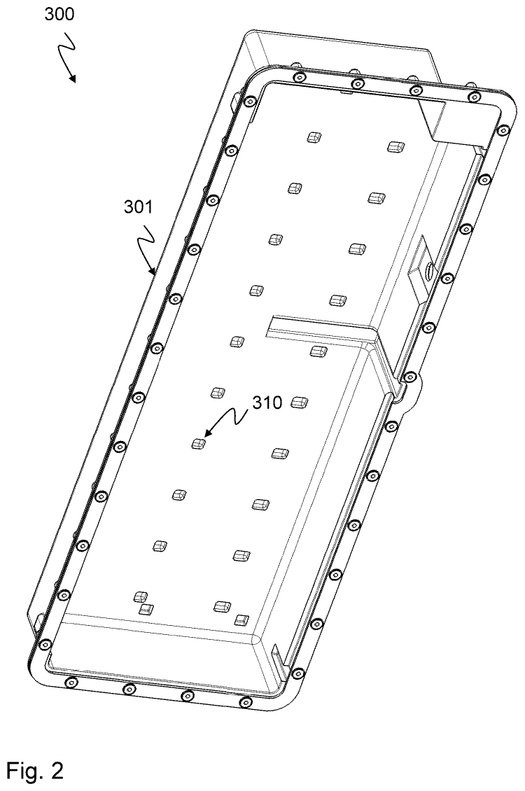

The centering elements 120a, 120b are configured so as to interlock with corresponding counter-centering elements 310 of the housing 300, as shown as an example in FIG. 2. These counter-centering elements 310 of the housing 300 can be configured, for example, as centering recesses and/or centering grooves, as shown in FIG. 2.

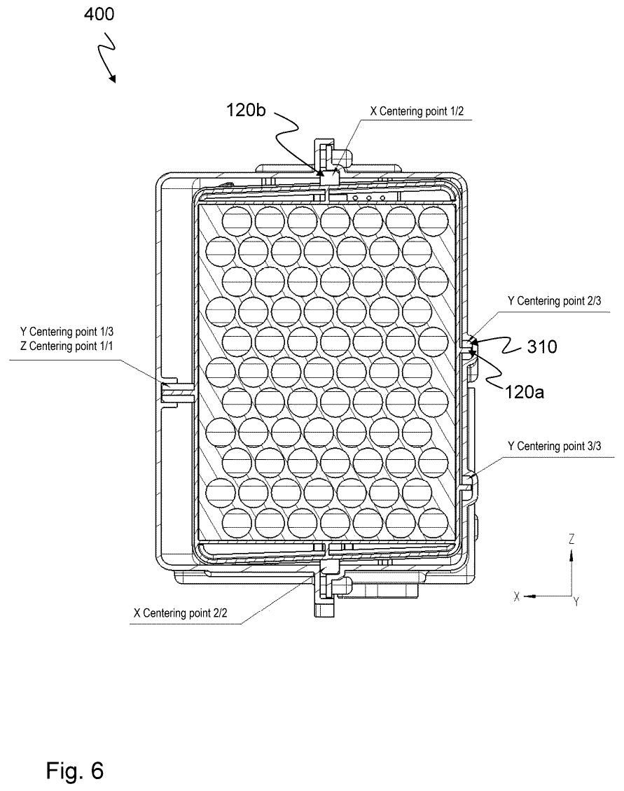

The various centering elements 120a, 120b are configured, for example, for securing the stacked battery module 100 in the housing 300 of the battery system 400 in three different spatial dimensions. A corresponding centering concept is described in more detail in FIG. 6.

The one or several centering elements 120a, 120b can be provided in a cross or bar shape. Half-crosses or two beams of different or identical lengths and shapes crossed in any way are also considered herein to be cross-shaped.

A respective centering element 120a is provided for centering the stacked battery module 100 in transversal direction 111a and/or longitudinal direction 111b of the corresponding outer surface 110a of the battery module housing 110. In FIG. 1, the centering elements 120a, 120b are positioned along various outer surfaces 110a, 110b, 110c, 110d of the battery module housing 110, in order to secure and center in three different spatial directions.

The battery modules 100 shown in FIG. 1, which is made of plastic, have centering points on the outer surfaces 110a, 110b, 110c, 110d, which are here called centering elements 120a and 120b, at which the battery module 100 can later be held by the housing 300, as shown as an example in FIG. 3.

FIG. 2 shows a 3D representation of a housing 300 according to the present disclosure of a battery system having counter-centering elements according to an example, in which the upper housing section 301 is depicted.

In this example, the housing 300 includes an upper housing section 301, which is represented as an example in FIG. 2, and a lower housing section 302, which is represented as an example in FIG. 3.

The housing 300, which is comprised of two or several housing sections 301, 302, has an internal geometry (for example, recesses or grooves) which represent a matching part to the centering points of the module.

Generally speaking, the one or several centering elements 120a, 120b are configured so as to interlock with the corresponding counter-centering elements 310 of the housing 300. These counter-centering elements 310 of the housing 300 can be shaped as centering recesses and/or centering grooves.

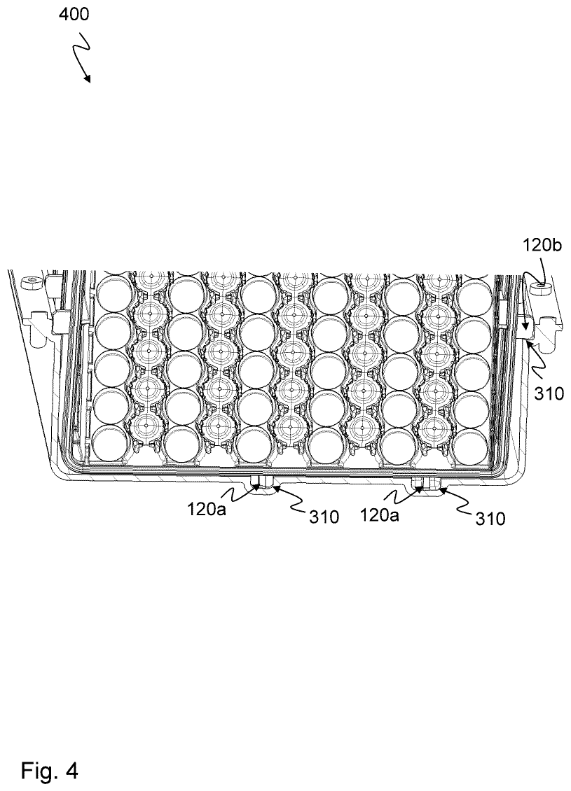

When the module stack 150 is inserted into the lower section 302 of the housing 300, as shown in FIGS. 3 and 4, a portion of the centering points or centering elements 120a, 120b of the battery module 100 are located in the counterparts or counter-centering elements 310 in the housing 300 and the battery module stack 150 is secured in two dimensions.

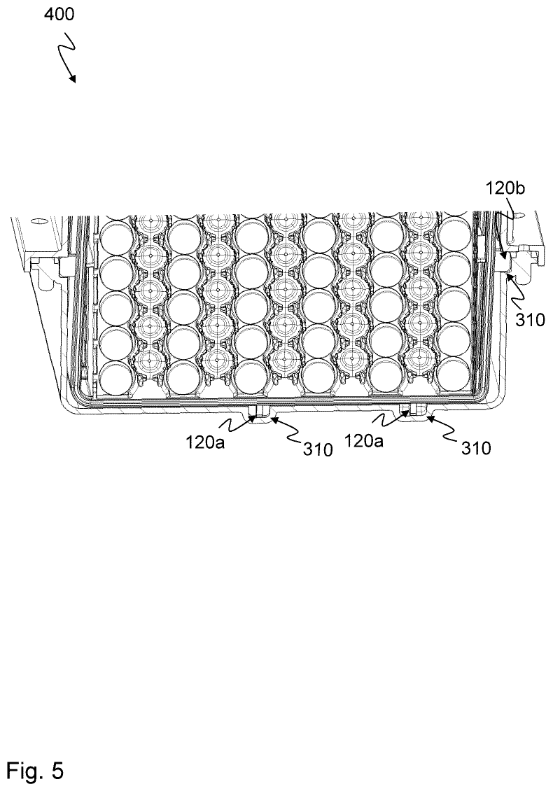

With the closing of the housing 300 or the attachment of the upper housing section 301 (see FIG. 2), the rest of the centering elements 120a, 120b are fixed on the battery module 100, as shown in FIG. 5. Centering points or centering elements can also be positively secured in their position between the housing sections 301, 302, wherein the battery module stack 150 is also secured in the housing in the direction of assembly as soon as the housing sections 301, 302 are attached to each other, for example by means of screw connections or in another way, as shown in FIG. 5.

The module stack is secured in this way in all three dimensions with the aid of the centering points or centering elements 120a, 120b, as shown in more detail in FIG. 6. A centering point or centering element 120a, 120b positioned in a recess or a counter-centering element 310 in the housing 300 can thereby absorb forces in one or also in several directions depending on the configuration.

To disassemble and remove the battery module stack 150, for example, for repair or disposal, merely the upper housing section 301 must be separated from the lower housing section 302. The battery module stack 150 can subsequently be lifted out of the lower housing section 302 without further ado.

The battery system 400 for a battery electric vehicle shown in FIGS. 3 to 6 comprises: a plurality of stackable battery modules 100, as described in FIG. 1 above, which are stacked to form a battery module stack 150, wherein the battery module housings 110 for the respective battery modules 100 interlock and laterally encase the stacked battery modules 100, as shown in detail in FIG. 3.

The battery system 400 comprises a housing 300, which encases the battery module stack 150, wherein the housing 300 comprises a plurality of counter-centering elements 310 configured for interlocking with one or several centering elements 120a, 120b of the battery module housing 110, so that the battery module stack 150 is secured and centered in the housing 300.

The housing 300 comprises two or several housing sections 301, 302 that can be assembled to form the housing 300. During assembly of the housing sections 301, 302 to form the housing 300, the one or several centering elements 120a, 120b engage with the corresponding counter-centering elements 310 of the housing 300 and secure and center the battery module stack 150 in the housing 300.

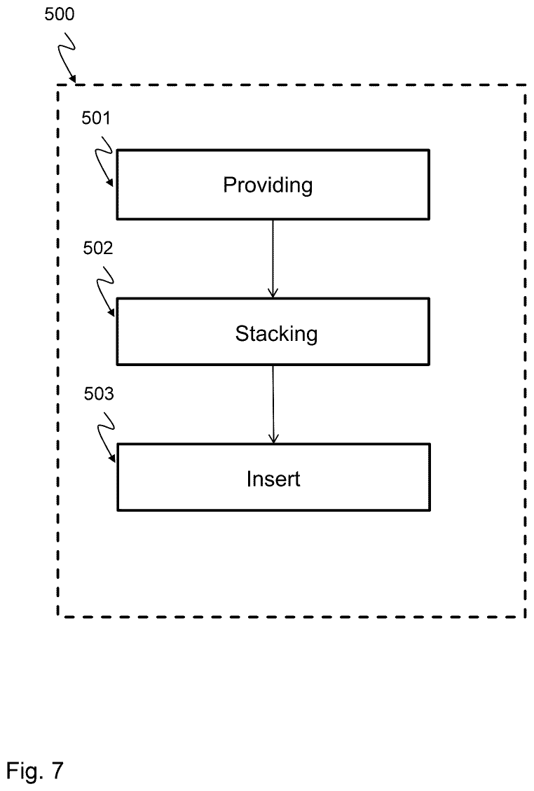

FIG. 7 shows a schematic representation of a method 500 according to the present disclosure for producing for a battery system for a battery electric vehicle.

The method 500 comprises a provision 501 of a plurality of battery modules 100 with respectively a plurality of battery cells 102; a battery module housing 110 arranged so as to frame the plurality of battery cells 102; and one or several centering elements 120a, 120b arranged on one or several outer surfaces 110a, 110b, 110c, 110d of the battery module housing 110, as described as an example in FIGS. 1 to 6.

The method 500 comprises a stacking 502 of the battery modules 100 to form a battery module stack 150, wherein the respective battery modules 100 interlock and laterally encase the stacked battery modules 100 during the stacking 502 of the battery module housing 110, as described in FIGS. 1 to 6.

The method 500 comprises the insertion 503 of the battery module stacks 150 into a housing 300 of the battery system 400, wherein the centering elements 120a, 120b of the respective battery module housings 110 secure and center the battery module stack 150 in the housing 300 during the insertion, as described in FIGS. 1 to 6.

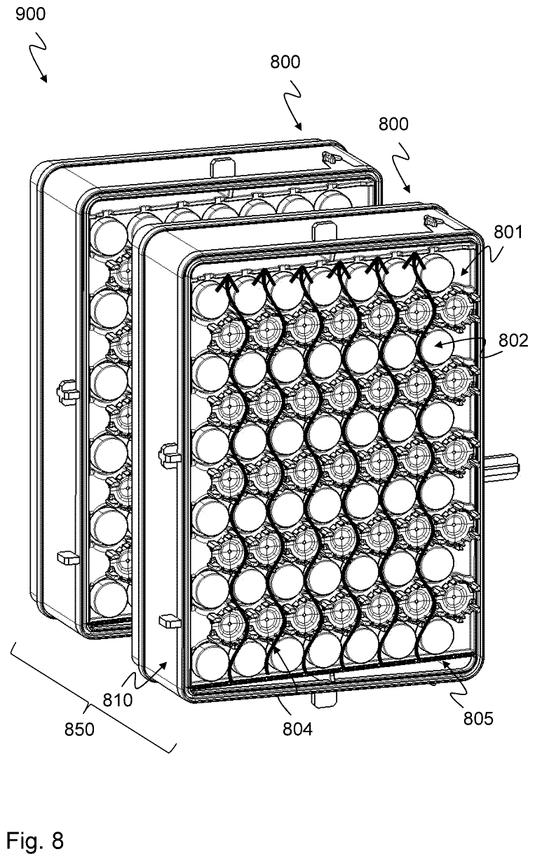

FIG. 8 shows a 3D representation of a battery system 900 according to the present disclosure with two exemplary stackable battery modules 800 according to an example.

The battery system 900 comprises a plurality of stackable battery modules 800, which can be stacked to form a battery module stack 850. In FIG. 8 is represented an exemplary quantity of two such battery modules 800, which can both be provided with an identical configuration.

The stackable battery module 800 comprises: a plurality of battery cells 802; and a battery module housing 810, which is arranged so as to frame a plurality of battery cells 802. The battery cells 802 can be configured in the same way as the battery cells 102 depicted above in FIGS. 1 to 6. The plurality of battery cells 802 can be directly encircled by the battery module housing 810, which serves as carrier for the battery cells 802. In FIG. 8, however, the battery module housing 810 comprises a different quantity of battery cells 802 (namely 8×5=40, for example) than the battery module housing 110 depicted in FIG. 1.

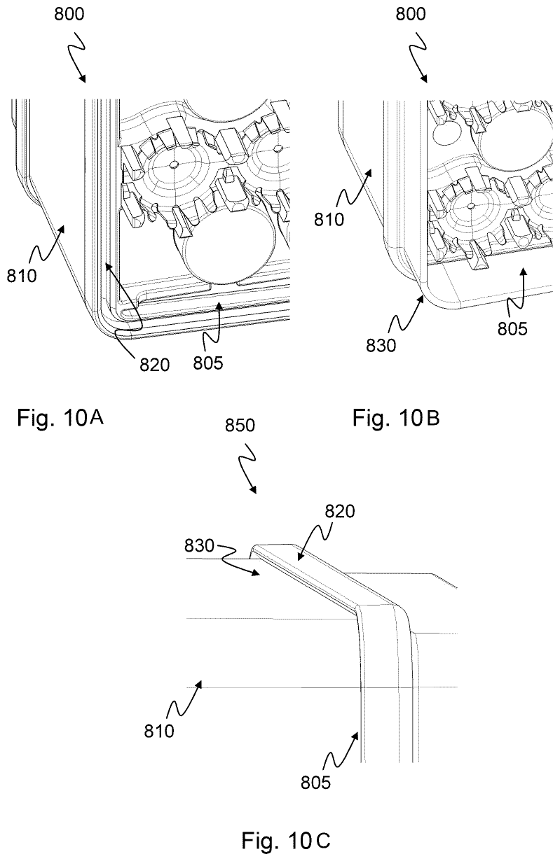

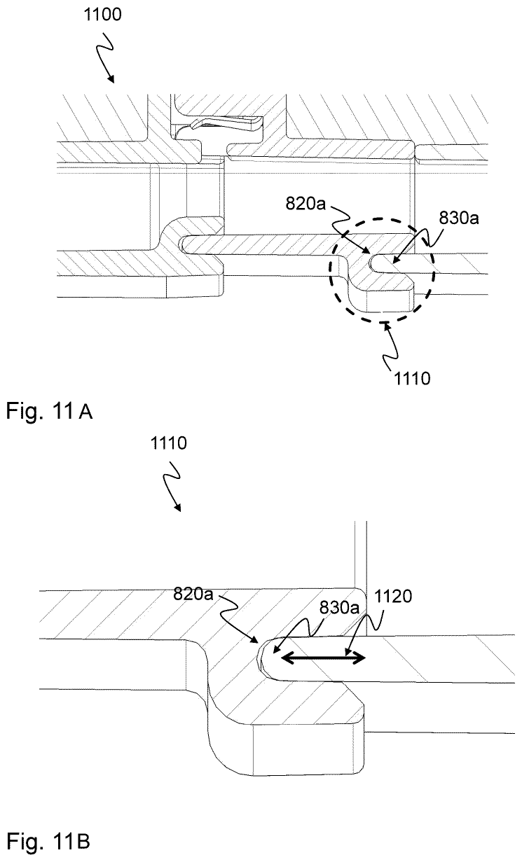

The battery module housing 810 has a laterally framed tongue element 830 and a laterally framed groove element 820, which corresponds to the tongue element 830, as described as described in more detail in FIGS. 10A to 12D.

During stacking of the battery module 800 with one (or several) other battery module 800 to form a battery module stack 850, the tongue element 830 of a battery module 800 interlocks with the groove element 820 of a further battery module 800. A coolant channel 801 is configured between the battery module 800 and the further battery module 800.

The coolant distributor 805 can be integrated, for example, into the lower side of the battery module 800, as depicted as an example in FIG. 8. Coolant 804 can flow into the battery module 800 by means of the coolant distributor 805 and over the battery cells 802 by means of the coolant channel 801, in order to cool these, as schematically represented with the aid of the curved arrows.

The battery cells 802 can be actively cooled with the battery system 900 described herein as a result of the resulting power dissipation and the heat produced therewith, so that the shortest possible recharge time possible for the battery system can be achieved. The battery system 900 can use for this purpose a so-called direct or immersion cooling, in which the coolant 804 must be electrically non-conductive.

A coolant channel 801 is configured in the battery system 900 by joining two battery module housings 810 and a coolant distributor (not illustrated). The coolant channel 801 and the coolant distributor 805 are configured so closely that the cooling medium or coolant 804 can flow from one side of the battery system to the other, such as from front to back (coolant distributor 805) and from bottom to top (coolant channel 801), as shown in FIG. 8. All other combinations are likewise possible.

Additional seals for sealing the coolant channel 801 and the coolant distributor 805 are omitted in this battery system 900. The solution relies on the tongue and groove concept, in which the tongue and groove connection is configured to be so flexible that component tolerances and size changes caused by temperature fluctuations can be compensated, as described in more detail in the following FIGS. 10A to 12D.

The battery system 900 represented in FIG. 8 can be used in a battery electric vehicle. It comprises: a plurality of stacked battery modules 800, which are stacked to form a battery module stack 850, wherein the tongue element 830 (depicted in more detail in FIGS. 10B and 10C) of one battery module 800 interlocks with the groove element 820 (depicted in more detail in FIGS. 10A and 10C) of a corresponding further battery module 800. A coolant channel 801 is formed between the battery module 800 and the further battery module 800. The battery system 900 comprises a housing (which is not depicted in the figures), that encases the battery module stack 150 and protects against leakage of the coolant 804.

The battery system 900 additionally comprises a coolant distributor 805, also described as a “manifold,” which introduces the coolant 804 into the coolant channel 801 between the stackable battery modules 800.

A cross section of the coolant distributor 805, via which the coolant 804 can be introduced into the coolant channels 801 between the battery modules 800, can be many times larger than the cross section of the coolant channels 801 between the battery modules 800.

As already described above, such a coolant distributor 805 is configured with openings in the area of the coolant channel 801, so that the cooling medium or coolant 804, can flow out of the coolant distributor 805 into the coolant channel 801. Ideally, approximately the same amount of coolant should flow from the coolant distributor into each coolant channel 801. For this purpose, the coolant distributor 805 is dimensioned relatively large in comparison with the openings in the coolant channels 801. All the battery modules 800 can then be advantageously uniformly produced (off-tool). During the installation of the modules, that is, the battery modules 800, in a string there is also no need to take into account the order of the modules 800.

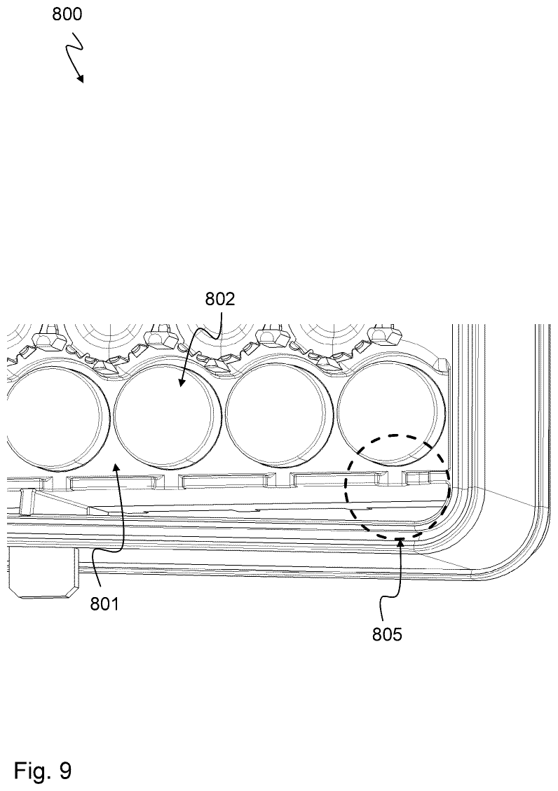

FIG. 9 shows a perspective view of a coolant distributor 805 and breakthrough to the coolant channel 801 between the two battery modules 800 of FIG. 8 according to an example.

A coolant distributor 805 is configured for introducing a coolant 804 into the coolant channel 801 between the stackable battery modules 800.

A cross section of the coolant distributor 805, via which the coolant 804 can be introduced into the coolant channels 801 between the battery modules 800, is many times larger than the cross section of the coolant channels 801 between the battery modules 800.

As shown in FIG. 8, the feed lines or the coolant channels 801 for the coolant 804 are integrated into the battery module housing 810.

The feed lines are fitted together during assembly. The feed lines are open in the hollow space, so that the coolant 804 can flow into the hollow space.

FIG. 10A shows a perspective view of the battery module 800 of FIG. 8 where the groove element 820 according to an example is represented, and FIG. 10B shows a perspective view of the battery module 800 of FIG. 8 where the tongue element 830 according to an example is represented. FIG. 10C shows a perspective view of the battery module 800 of FIG. 8 where the configuration of the coolant distributor 805 and breakthrough to the coolant channel 801 is represented between the groove element 820 and the tongue element 830 according to an example.

A stackable battery module 800 for a battery system 900, as described in FIGS. 8 and 9, comprises: a plurality of battery cells 802; and a battery module housing 810, which is arranged so as to frame a plurality of battery cells 802. The battery module housing 810 has a laterally framed tongue element 830 and a laterally framing groove element 820, which fits together with the laterally framed tongue element 830.

As described above, the tongue element 830 of a battery module 800 interlocks with the groove element 820 of a further module 800 when the battery module 800 is stacked with a further battery module 800 to form a battery module stack 850. A coolant channel 801 is formed by the battery module 800 and the further battery module 800.

The tongue element 830 and/or groove element 820 can be configured as one piece with the battery module housing 810, for example, as a single injection molded part.

The tongue element 830 of the battery module 800 and groove element 820 of the further battery module 800 form the wall of the coolant distributor 805. The coolant channel 801 is formed by the two adjacent modules.

When the tongue element 830 of one battery module 800 interlocks with the groove element 820 of a further battery module 800, the tongue element 830 and groove element 820 can form the tongue and groove type connection.

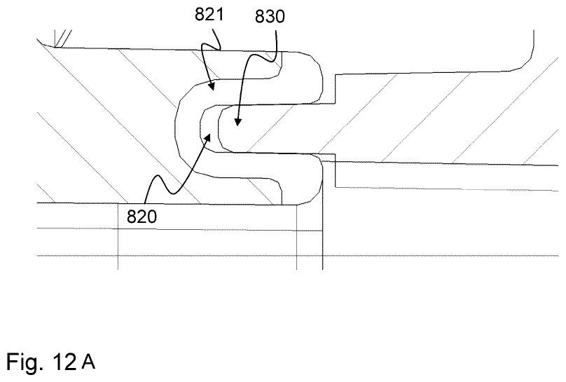

This tongue and groove connection can be configured to be a positive connection perpendicular to the interlocking direction 1120 of the tongue element 830 (see FIG. 11A, 11B) with the groove element 820.

The tongue and groove connection can be configured so as to slide together in an interlocking direction 1120, so that the battery module housing can expand when the temperature rises, allowing the tongue element 830 to move further into the groove element 820.

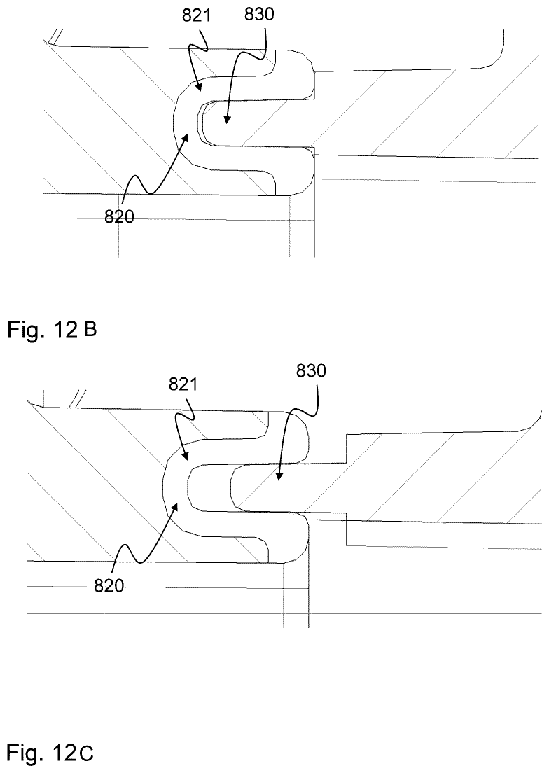

The groove element 820 has a notch 821, which is shown in more detail in FIGS. 12B to 12D, which configures the coolant channel 801 between the battery module 800 and the further battery module 800 during the interlocking of the tongue element 830 with the groove element 820. With this, the coolant channel 801 is formed between the battery modules 800 and achieves at the same time a sealing of the battery module 800 to the outside.

FIG. 11A shows a 3D representation of the battery module 800 of FIG. 8 where the tongue and groove connection 1110 according to an example is represented. FIG. 11B shows an enlarged representation of a tongue and groove connection 1110 of FIG. 11A. In FIGS. 11A and 11B refer especially to outer seal of the module stack and thus of the coolant distributor.

It is shown how a tongue element 830a of a battery module 800 interlocks with the groove element 820a of an adjacent battery module 800, and how the two battery modules configure a coolant channel. The interlocking direction 1120 in which the battery module 800 engages with a further adjacent battery module 800 in order to form the tongue and groove connection 1110, is indicated by the arrow showing the interlocking direction 1120.

FIGS. 12A, 12B, and 12C show a 3D representation of a tongue and groove connection formed from the laterally framed groove element 820 and the laterally framed tongue element 830 and the configuration of a coolant distributor 805 and breakthrough to the coolant channel 801 between the groove element 820 and tongue element 830 for two stacked battery modules 800 according to an example.

To illustrate the effect of the constant cross section, FIG. 12A shows the initial position, FIG. 12B shows the condition with temperature-induced expansion, and FIG. 12C shows the condition with temperature-induced contraction.

This is not the same tongue and groove system as the one depicted in FIGS. 11A and 11B. While FIGS. 11A and 11B show the outer seal of the module stack, and thus also the coolant distributor, FIGS. 12A-C show the separation between the coolant distributor and the coolant channel, also sealed with tongue and groove connection. Only this groove element 820 in FIGS. 12A-C has the recesses to allow coolant to flow through in the intended manner.

The tongue element 830 of a battery module 800 interlocks with the groove element 820 of an adjacent battery module 800. The coolant distributor 805 and breakthrough to the coolant channel 801 is configured between the two battery modules 800.

The groove element 820 has a notch 821 or recess which forms the coolant distributor 805 and breakthrough to the coolant channel 801 between the battery module 800 and the further battery module 800 when the tongue element 830 interlocks with the groove element 820. At the other locations between tongue element 830 and groove element 820, the tongue and groove connection is sealed to inhibit any leaks of coolant 804 to the outside.

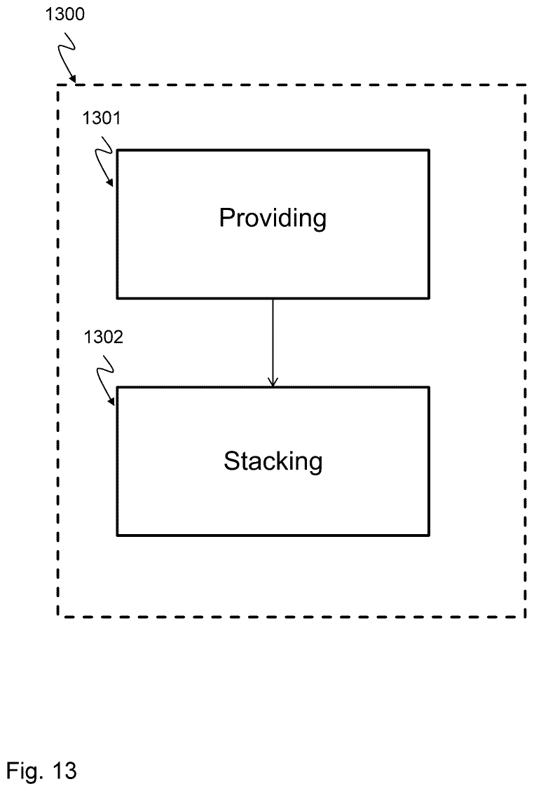

FIG. 13 shows a schematic representation of a method 1300 according to the present disclosure for producing a battery system for a battery electric vehicle.

The method 1300 comprises a provision 1301 of a plurality of battery modules 800 with respectively a plurality of battery cells 802; and a battery module housing 810 arranged so as to frame a plurality of battery cells 802, wherein this battery module housing 810 has a laterally framed tongue element 830 and a groove element 820, which fits together with the laterally framed tongue element 830, as described above in FIGS. 8 to 12 above.

The method 1300 comprises a stacking 1302 of the battery module 800 with a further battery module 800 into a battery module stack 850, wherein the tongue element 830 of the battery module interlocks with the groove element 820 of the further batter module 800 during stacking 1302 and a coolant channel 801 is configured between the battery module (800) and the further battery module 800, as depicted above in FIGS. 8 to 12.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A stackable battery module for a battery system of a battery electric vehicle, comprising:
a plurality of battery cells; and
a battery module housing, arranged to frame the plurality of battery cells to form the battery module, with a plurality of the battery modules laterally framed and configured to form a battery stack, the battery module housings of the plurality of battery modules are configured to interlock and laterally encase the battery stack during stacking; and
at least one centering element is arranged on at least one outer surface of one of the battery module housings, and the at least one centering element is configured to secure and center the battery stack in a housing of the battery system.

2. The stackable battery module according to claim 1, wherein the at least one centering element is configured as one piece with the one of the battery module housings.

3. The stackable battery module according to claim 1, wherein the at least one centering element is configured to interlock with a corresponding counter-centering element of the housing.

4. The stackable battery module according to claim 3, wherein the corresponding counter-centering element of the housing includes at least one of centering grooves and centering recesses.

5. The stackable battery module according to claim 1, wherein the at least one centering element is configured to secure the battery module in the housing of the battery system in three different spatial dimensions.

6. The stackable battery module according to claim 1, wherein the at least one centering element is configured in a shape of a cross or a beam.

7. The stackable battery module according to claim 1, wherein the at least one centering element is configured to center the battery module in at least one of a transversal direction and a longitudinal direction of the at least one outer surface of the battery module housing.

8. A battery system for a battery electric vehicle, comprising:
a plurality of stackable battery modules according to claim 1 that are stacked to form the battery stack; and
the housing, which encases the battery stack, and the housing comprises a plurality of counter-centering elements configured to interlock with the at least one centering element of the one of the battery module housings, so that the battery stack is secured and centered in the housing.

9. The battery system according to claim 8, wherein the housing comprises at least two housing parts which are configured to be assembled to form the housing, and the at least one centering element interlocks with a corresponding counter-centering element of the plurality of counter-centering elements of the housing and secures and centers the battery stack in the housing during assembly of the at least two housing parts to form the housing.

10. A stackable battery module for a battery system in a battery electric vehicle, comprising:
a plurality of battery cells; and
a battery module housing arranged so as to frame the plurality of battery cells and form the battery module, the battery module housing includes a laterally framing tongue element and a laterally framing groove element, and the laterally framing groove element fits together with a second laterally framing tongue element,
wherein the battery module is configured to interlock with a second battery module to form a battery stack and the laterally framing tongue element of the battery module interlocks with the laterally framing groove element of the second battery module to form a coolant channel through the battery module and the second battery module.

11. The stackable battery module according to claim 10, wherein at least one of the laterally framing tongue element and the laterally framing groove element are configured as one piece with the battery module housing.

12. The stackable battery module according to claim 10, wherein the laterally framing tongue element of the battery module with the laterally framing groove element of the second battery module form a wall of a coolant distributor for distributing coolant through the coolant channel.

13. The stackable battery module according to claim 12, wherein the laterally framing tongue element with the laterally framing groove element form a tongue and groove connection with the insertion of the laterally framing tongue element of the battery module into the laterally framing groove element of the second battery module.

14. The stackable battery module according to claim 13, wherein the tongue and groove connection is configured to positively fit perpendicular to an interlocking direction of the laterally framing tongue element in the laterally framing groove element.

15. The stackable battery module according to claim 13, wherein the tongue and groove connection is configured to slide together in an interlocking direction.

16. The stackable battery module according to claim 12, wherein the laterally framing groove element includes a notch forming a connection from the coolant distributor to the coolant between the battery module and the second battery module with an interlocking of the laterally framing tongue element and the laterally framing groove element.

17. A battery system for an electric vehicle, comprising:
a plurality of stackable battery modules according to claim 10, the plurality of stackable battery modules stacked to form a battery stack, the laterally framing tongue element of the battery module interlocks with the laterally framing groove element of the second battery module to form the coolant channel between the battery module and the second battery module; and
a housing encasing the battery module stack to protect against leakage.

18. The battery system according to claim 17, further comprising:
a coolant distributor to introduce a cooling medium into the coolant channel, and a cross section of the coolant distributor that is configured to introduce the cooling medium into the coolant channel is larger than the cross section of the coolant channel between the battery module and the second battery module.
